(19) United States
(12) Patent Application Publication
(10) Pub. No.: US 2025/0002824 A1
(43) Pub. Date: Jan. 2, 2025

(54) Washing or Cleaning Agent Product Form

(71) Applicant: Henkel AG & Co. KGaA, Duesseldorf (DE)

(72) Inventors: Till Frey, Düsseldorf (DE); Mareile Job, Düsseldorf (DE)

(21) Appl. No.: 18/741,203

(22) Filed: Jun. 12, 2024

(30) Foreign Application Priority Data
Jun. 15, 2023 (DE) 102023205585.6

(51) Int. Cl. C11D 17/00; C11D 1/83; C11D 3/20

(52) U.S. Cl. CPC C11D 17/0026; C11D 1/83; C11D 3/2065; C11D 3/2096; C11D 2111/12; C11D 2111/14

(57) ABSTRACT

A gel-like washing or cleaning agent product form which, in addition to good washing or cleaning performance, is characterized by high chemical and physical stability and simple manufacturability using sustainable substances and related methods. The product can include, amongst other things, at least one low-molecular-weight gelling agent having a molar mass of up to 2000 g/mol, at least one active washing or active cleaning agent, and at least one additional compound described by chemical formula (I).

### FIELD OF INVENTION

The present invention relates to a gel-like active substance-containing washing or cleaning agent product form on the basis of a low-molecular-weight gelling agent. The application also relates to a method for producing said washing or cleaning agent product form and to methods for washing textiles or methods for cleaning hard surfaces using such a washing or cleaning agent product form.

### BACKGROUND

Continuously changing requirements are placed on the packaging and product forms of washing and cleaning agents. The main focus has, for quite some time, been on the convenient dosing of washing agents and cleaning agents by the consumer and the simplification of the work steps necessary for carrying out a washing or cleaning method. A technical solution is provided by pre-portioned washing agents or cleaning agents—for example, water-soluble containers having one or more receiving chambers for solid or liquid washing agents or cleaning agents. Due to their dissolution behavior, liquid or gel-like washing or cleaning agents are increasingly being favored over solid washing or cleaning agents.

An alternative to filled water-soluble containers is offered by the washing or cleaning agent tablets, and recently by washing or cleaning agent gel bodies, in the field of pre-portioned washing or cleaning agents, as described, for example, in international patent application WO 2021/013412 A1.

A substantial factor for the manufacturability, packageability and meterability of washing or cleaning agent gels or gel bodies is the stable viscosity or stable spatial form thereof, which in turn are determined inter alia by the gelling agents used. Although a plurality of different gelling agents are available, their incorporation in active washing or active cleaning matrices and subsequent reliable and stable formation of a gel network is challenging. This also applies in particular to increasing demands on the sustainability of washing or cleaning agents, which, for example, also reduces the number of active substances and auxiliary substances that can be used.

### SUMMARY OF THE INVENTION

Against this background, the object of the present application was to provide a gel-like washing or cleaning agent product form which, in addition to good washing or cleaning performance, is characterized by high chemical and physical stability and simple manufacturability using sustainable substances.

### DETAILED DESCRIPTION OF THE INVENTION

To achieve these objects, a gel-like washing or cleaning agent product form is suitable, which contains
a) at least one low-molecular-weight gelling agent having a molar mass of up to 2000 g/mol
b) at least one compound of the general formula (I)

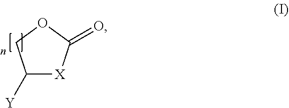

where
X represents a methylene group or oxygen atom
Y represents a hydrogen atom or a methyl group,
n represents a number from 1 to 3;
c) at least one active washing or active cleaning agent.

The gel-like washing or cleaning agent product form contains, as a first substantial component, at least one low-molecular-weight gelling agent having a molar mass of up to 2000 g/mol. The use of gelling agents having a molar mass of from 200 g/mol to 2000 g/mol, preferably from 200 g/mol to 1000 g/mol, has proven to be particularly advantageous with respect to the manufacturability, packageability and later use.

The percentage by weight of the low-molecular-weight gelling agent a) with respect to the total weight of the washing or cleaning agent product form, based on the total weight thereof, is preferably from 0.01 to 15 wt. %, preferably from 0.1 to 10 wt. % and in particular from 1 to 4 wt. %.

In a preferred embodiment, the low-molecular-weight gelling agent has a solubility in water of less than 0.1 g/L (20° C.). The solubility of the organic gelator compound is determined at 20° C. in bidistilled, demineralized water.

Furthermore, gelling agents are preferably suitable which comprise a structure containing at least one hydrocarbon structural unit having 6 to 20 carbon atoms (preferably at least one carbocyclic, aromatic structural unit) and additionally an organic structural unit that is covalently bonded to the aforementioned hydrocarbon unit and has at least two groups selected from —OH, —NH—, or mixtures thereof.

Particularly preferred washing or cleaning agent product forms are characterized in that the washing or cleaning agent product forms contain at least one benzylidene alditol compound of formula (GB-I) as gelling agent

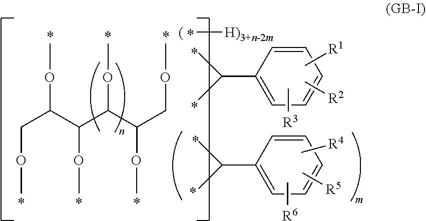

wherein
represents a covalent single bond between an oxygen atom of the alditol backbone and the provided functional group,
m represents 0 or 1, preferably 1,
m represents 0 or 1, preferably 1,
R¹, R² and R³ represent, independently of one another, a hydrogen atom, a halogen atom, a C₁-C₄ alkyl group, a cyano group, a nitro group, an amino group, a carboxyl group, a hydroxyl group, a —C(═O)—NH—NH₂ group, an —NH—C(═O)—(C₂-C₄ alkyl) group, a C₁-C₄ alkoxy group, a C₁-C₄ alkoxy C₂-C₄ alkyl group, with two of the functional groups forming, together with the remainder of the molecule, a 5-membered or 6-membered ring,
R⁴, R⁵ and R⁶ represent, independently of one another, a hydrogen atom, a halogen atom, a C₁-C₄ alkyl group, a cyano group, a nitro group, an amino group, a carboxyl group, a hydroxyl group, a —C(═O)—NH—NH₂ group, an —NH—C(═O)—(C₂-C₄ alkyl) group, a C₁-C₄ alkoxy group, a C₁-C₄ alkoxy C₂-C₄ alkyl group, with two of the functional groups forming, together with the remainder of the molecule, a 5-membered or 6-membered ring.

Due to the stereochemistry of the alditols, it should be mentioned that said benzylidene alditols according to the invention are suitable in the L configuration or in the D configuration or in a mixture of the two. Due to natural availability, the benzylidene alditol compounds are preferably used according to the invention in the D configuration. It has proven preferable if the alditol backbone of the benzylidene alditol compound according to formula (GB-I) contained in the shaped body is derived from D-glucitol, D-mannitol, D-arabinitol, D-ribitol, D-xylitol, L-glucitol, L-mannitol, L-arabinitol, L-ribitol or L-xylitol.

Particularly preferred are those washing or cleaning agent product forms which are characterized in that R¹, R², R³, R⁴, R⁵ and R⁶ according to the benzylidene alditol compound of formula (GB-I) mean, independently of one another, a hydrogen atom, methyl, ethyl, chlorine, fluorine, or methoxy, preferably a hydrogen atom.

In the formula (GB-I), n preferably represents 1.

m according to the benzylidene alditol compound of formula (GB-I) preferably represents 1.

The washing or cleaning agent product form very particularly preferably contains at least one compound of formula (GB-II) as the benzylidene alditol compound of formula (GB-I)

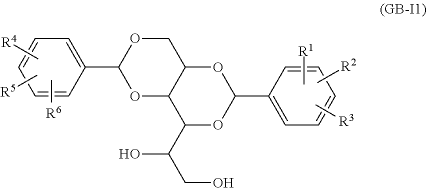

where R¹, R², R³, R⁴, R⁵ and R⁶ are as defined in formula (I). Most preferably, according to formula (GB-I1), R¹, R², R³, R⁴, R⁵ and R⁶ represent, independently of one another, a hydrogen atom, methyl, ethyl, chlorine, fluorine, or methoxy, preferably a hydrogen atom.

Most preferably, the benzylidene alditol compound of formula (GB-I) is selected from 1,3:2,4-di-O-benzylidene-D-sorbitol; 1,3:2,4-di-O-(p-methylbenzylidene)-D-sorbitol; 1,3:2,4-di-O-(p-chlorobenzylidene)-D-sorbitol; 1,3:2,4-di-O-(2,4-dimethylbenzylidene)-D-sorbitol; 1,3:2,4-di-O-(p-ethylbenzylidene)-D-sorbitol; 1,3:2,4-Di-O-(3,4-dimethylbenzylidene)-D-sorbitol or mixtures thereof.

Preferred washing or cleaning agent product forms contain at least one 2,5-diketopiperazine compound of formula (GB-II) as the gelling agent

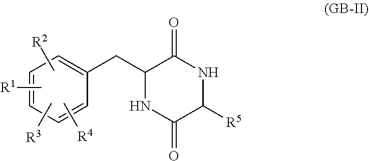

wherein
R¹, R², R³ and R⁴ represent, independently of one another, a hydrogen atom, a hydroxyl group, a (C₁-C₆) alkyl group, a (C₂-C₆) alkenyl group, a (C₂-C₆) acyl group, a (C₂-C₆) acyloxy group, a (C₁-C₆) alkoxy group, an amino group, a (C₂-C₆) acylamino group, a (C₁-C₆) alkylaminocarbonyl group, an aryl group, an aroyl group, an aroyloxy group, an aryloxy group, an aryl-(C₁-C₄) alkyloxy group, an aryl-(C₁-C₃) alkyl group, a heteroaryl group, a heteroaryl-(C₁-C₃) alkyl group, a (C₁-C₄) hydroxyalkyl group, a (C₁-C₄) aminoalkyl group, a carboxy-(C₁-C₃) alkyl group, where at least two of the functional groups R¹ to R⁴ can form, together with the remainder of the molecule, a 5-membered or 6-membered ring,
R⁵ represents a hydrogen atom, a linear (C₁ to C₆) alkyl group, a branched (C₃ to C₁₀) alkyl group, a (C₃ to C₆) cycloalkyl group, a (C₂-C₆) alkenyl group, a (C₂-C₆) alkynyl group, a (C₁-C₄) hydroxyalkyl group, a (C₁-C₄) alkoxy-(C₁-C₄) alkyl group, a (C₁-C₄) acyloxy-(C₁-C₄) alkyl group, an aryloxy-(C₁-C₄) alkyl group, an O-(aryl-(C₁-C₄) alkyl)oxy-(C₁-C₄) alkyl group, a (C₁-C₄) alkylsulfanyl-(C₁-C₄) alkyl group, an aryl group, an aryl-(C₁-C₃) alkyl group, a heteroaryl group, a heteroaryl-(C₁-C₃) alkyl group, a (C₁-C₄) hydroxyalkyl group, a (C₁-C₄) aminoalkyl group, an N—(C₁-C₄) alkylamino-(C₁-C₄) alkyl group, an N,N—(C₁-C₄) dialkylamino-(C₁-C₄) alkyl group, an N—(C₂-C₅) acylamino-(C₁-C₄) alkyl group, an N—(C₂-C₅) acyl-N—(C₁-C₄) alkylamino-(C₁-C₄) alkyl group, an N—(C₂-C₈) aroyl-N—(C₁-C₄) alkylamino-(C₁-C₄) alkyl group, an N,N—(C₂-C₈) diacylamino-(C₁-C₄) alkyl group, an N-(aryl-(C₁-C₄) alkyl)amino-(C₁-C₄) alkyl group, an N,N-di(aryl-(C₁-C₄) alkyl)amino-(C₁-C₄) alkyl group, a (C₁-C₄) carboxyalkyl group, a (C₁-C₄) alkoxycarbonyl-(C₁-C₃) alkyl group, a (C₁-C₄) acyloxy-(C₁-C₃) alkyl group, a guanidino-(C₁-C₃) alkyl group, an aminocarbonyl(C₁-C₄) alkyl group, an N—(C₁-C₄) alkylaminocarbonyl-(C₁-C₄) alkyl group, an N,N-di((C₁-C₄) alkyl)aminocarbonyl-(C₁-C₄) alkyl group, an N—(C₂-C₅) acylaminocarbonyl-(C₁-C₄) alkyl group, an N,N—(C₂-C₅) diacylaminocarbonyl-(C₁-C₄) alkyl group, an N—(C₂-C₅) acyl-N—(C₁-C₄) alkylaminocarbonyl-(C₁-C₄) alkyl group, an N-(aryl-(C₁-C₄) alkyl)aminocarbonyl-(C₁-C₄) alkyl group, an N-(aryl-(C₁-C₄) alkyl)-N—(C₁-C₆) alkylaminocarbonyl-(C₁-C₄) alkyl group or an N,N-di(aryl-(C₁-C₄) alkyl)aminocarbonyl-(C₁-C₄) alkyl group.

It is preferred according to the invention if R³ and R⁴ according to formula (GB-II) represent a hydrogen atom. It is particularly preferred according to the invention if R², R³ and R⁴ according to formula (GB-II) represent a hydrogen atom. Therefore, particularly preferred shaped bodies according to the invention contain at least one 2,5-diketopiperazine compound according to formula (GB-IIa)

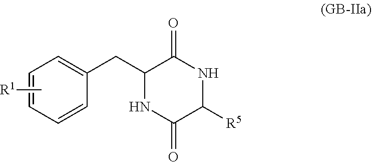

where R¹ and R⁵ are as defined under formula (GB-II) (vide supra).

It has been found to be preferred if the functional group R¹ according to formula (GB-II) and according to formula (GB-IIa) binds in the para position of the phenyl ring. Within the meaning of the present invention, shaped bodies according to the invention are therefore preferred which contain at least one 2,5-diketopiperazine compound according to formula (GB-IIb),

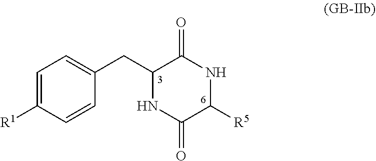

where R¹ and R⁵ are as defined under formula (GB-II) (vide supra). By way of illustration, numbers 3 and 6 positioned at the ring atoms in formula (GB-IIb) only mark positions 3 and 6 of the diketopiperazine ring, as they are generally used in the scope of the invention for naming all 2,5-diketopiperazines according to the invention.

The 2,5-diketopiperazine compounds of formula (GB-II) have centers of chirality at least on the carbon atoms in positions 3 and 6 of the 2,5-diketopiperazine ring. The numbering of ring positions 3 and 6 was illustrated by way of example in formula (GB-IIb). The 2,5-diketopiperazine compound of formula (GB-II) of the composition according to the invention is preferably, based on the stereochemistry of the carbon atoms at the 3 and 6 position of the 2,5-diketopiperazine ring, the configuration isomer 3S,6S, 3R,6S, 3S,6R, 3R,6R, or mixtures thereof, particularly preferably 3S,6S.

Preferred washing or cleaning agent product forms contain at least one 2,5-diketopiperazine compound of formula (GB-II) as the gelling agent, selected from 3-benzyl-6-carboxyethyl-2,5-diketopiperazine, 3-benzyl-6-carboxymethyl-2,5-diketopiperazine, 3-benzyl-6-(p-hydroxybenzyl)-2,5-diketopiperazine, 3-benzyl-6-iso-propyl-2,5-diketopiperazine, 3-benzyl-6-(4-aminobutyl)-2,5-diketopiperazine, 3,6-di(benzyl)-2,5-diketopiperazine, 3,6-di(p-hydroxybenzyl)-2,5-diketopiperazine, 3,6-di(p-(benzyloxy)benzyl)-2,5-diketopiperazine, 3-benzyl-6-(4-imidazolyl)methyl-2,5-diketopiperazine, 3-benzyl-6-methyl-2,5-diketopiperazine, 3-benzyl-6-(2-(benzyloxycarbonyl)ethyl)-2,5-diketopiperazine or mixtures thereof. In turn, compounds having the aforementioned configuration isomers are preferably suitable for selection.

It is also possible for the washing or cleaning agent product forms according to the invention to contain at least one diarylamidocystine compound of formula (GB-III) as the gelling agent a)

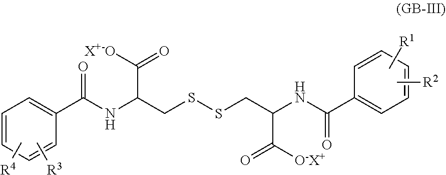

wherein
X⁺ independently represents a hydrogen atom or an equivalent of a cation,
R¹, R², R³ and R⁴ represent, independently of one another, a hydrogen atom, a halogen atom, a C₁-C₄ alkyl group, a C₁-C₄ alkoxy group, a C₂-C₄ hydroxyalkyl group, a hydroxyl group, an amino group, an N—(C₁-C₄-alkyl)amino group, an N,N-Di(C₁-C₄-alkyl)amino group, an N—(C₂-C₄-hydroxyalkyl)amino group, an N,N-Di(C₂-C₄-hydroxyalkyl)amino group, or R¹ with R² or R³ with R⁴ forms a 5-membered or 6-membered annulated ring, which in turn can in each case be substituted with at least one group from C₁-C₄ alkyl group, C₁-C₄ alkoxy group, C₂-C₄ hydroxyalkyl group, hydroxyl group, amino group, N—(C₁-C₄-alkyl)amino group, N,N-Di(C₁-C₄-alkyl)amino group, N—(C₂-C₄-hydroxyalkyl)amino group, N,N-Di(C₂-C₄-hydroxyalkyl)amino group.

Each of the stereocenters contained in the compound of formula (GB-III) can represent, independently of one another, the L or D stereoisomer. It is preferable according to the invention for the above-mentioned cystine compound of formula (GB-III) to be derived from the L stereoisomer of cysteine.

Said washing or cleaning agent product forms can contain at least one compound of formula (GB-III), in which R¹, R², R³ and R⁴ represent, independently of one another, a hydrogen atom, a halogen atom, a C₁-C₄ alkyl group, a C₁-C₄ alkoxy group, a C₂-C₄ hydroxyalkyl group, a hydroxyl group, or R¹ with R² or R³ with R⁴ forms a 5-membered or 6-membered annulated ring, which in turn can in each case be substituted with at least one group from C₁-C₄ alkyl group, C₁-C₄ alkoxy group, C₂-C₄ hydroxyalkyl group or hydroxyl group. In particular, shaped bodies which contain N,N′-dibenzoylcystine (R¹═R²=R³═R⁴=hydrogen atom; X⁺ independently=a hydrogen atom or an equivalent of a cation), in particular N,N′-dibenzoyl-L-cystine, as a diarylamidocystine compound of formula (GB-III) are particularly suitable.

The N—(C₈-C₂₄) hydrocarbylglyconamide compounds suitable as the gelling agent a) preferably have the formula (GB-IV)

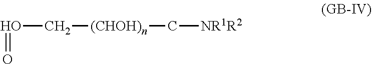

where
   n is 2 to 4, preferably 3 or 4, in particular 4;
R¹ is selected from hydrogen, C₁-C₁₆ alkyl groups, C₁-C₃ hydroxy or methoxyalkyl groups, preferably C₁-C₃ alkyl, hydroxyalkyl or methoxyalkyl groups, particularly preferably methyl;
R² is selected from C₈-C₂₄ alkyl groups, C₈-C₂₄ monoalkenyl groups, C₈-C₂₄ dialkenyl groups, C₈-C₂₄ trialkenyl groups, C₈-C₂₄ hydroxyalkyl groups, C₈-C₂₄ hydroxyalkenyl groups, C₁-C₃ hydroxyalkyl groups or methoxy-C₁-C₃ alkyl groups, preferably C₈-C₁₈ alkyl groups and mixtures thereof, more preferably C₈, C₁₀, C₁₂, C₁₄, C₁₆, and C₁₈ alkyl groups and mixtures thereof, most preferably C₁₂ and C₁₄ alkyl groups or a mixture thereof.

In particularly preferred embodiments, the functional group

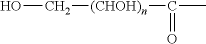

is one of a functional group derived from a glycuronic acid, in particular the glycuronic acid of a hexose (n=4). In particular, glucuronic acid should be mentioned as a preferred functional group. R¹ is preferably H or a short-chain alkyl functional group, in particular methyl. R² is preferably a long-chain alkyl functional group, for example a C₈-C₁₈ alkyl functional group.

Compounds of formula (GB-IV1) are therefore very particularly preferred

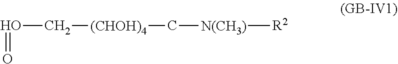

where R² has the meanings given for formula (GB-IV).

In a particularly preferred embodiment, the low-molecular-weight gelling agent a) is selected from the group of cyclic dipeptides, cyclic dipeptide derivatives and dibenzylidene sorbitols and mixtures thereof. Due to its technical effect, the group dibenzylidene sorbitol (DBS) is particularly preferred.

The low-molecular-weight gelling agent can comprise one, two, three or more compounds. The use of a single low-molecular-weight gelling agent is preferred.

The gel-like washing or cleaning agent product form comprises as a second substantial component a compound of the general formula (I)

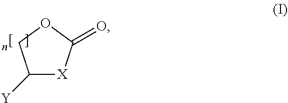

where
X represents a methylene group or an oxygen atom
Y represents a hydrogen atom or a methyl group
n represents a number from 1 to 3.

The proportion by weight of the compound of the general formula (I) with respect to the total weight of the washing or cleaning agent product form is preferably 0.5 to 10 wt. % and particularly preferably 1.0 to 8 wt. %.

With regard to their processability and the stability of the resulting gel-like washing or cleaning agent product forms, the use of compounds of the general formula (I) has proven to be particularly advantageous in which
X represents a methylene group,
Y represents a hydrogen atom
n represents a number from 1 to 3, preferably 2, or
X represents an oxygen atom,
Y represents a hydrogen atom or a methyl group,
n represents 1.

The manufacturability and physical stability of the gel-like washing or cleaning agent product form can be ensured by using an individual compound of general formula (I). However, in order to optimize process control or the product properties, it can be advantageous if the washing or cleaning agent product form contains two, three or more compounds of general formula (I).

In addition to the low-molecular-weight gelling agent and the compound of general formula (I), the gel-like washing or cleaning agent product forms further contain at least one active substance or active cleaning agent as a substantial component. The percentage by weight of the active washing or active cleaning substance with respect to the total weight of the washing or cleaning agent product form is preferably from 30 to 80 wt. %, more preferably from 40 to 75 wt. % and in particular from 50 to 70 wt. %.

Preferred washing or cleaning agent product forms contain a mixture of a plurality of active washing or active cleaning substances, preferably a mixture of active washing or active cleaning substances from different active substance classes. A washing or cleaning active substance from the group of surfactants, enzymes, active washing or active cleaning polymers, complexing agents and fragrance preparations are particularly preferred.

The group of surfactants includes the non-ionic, anionic, cationic and amphoteric surfactants. The compositions according to the invention can comprise one or more of the surfactants mentioned. The percentage by weight of the surfactant with respect to the total weight of the washing or cleaning agent product form is preferably from 30 to 70 wt. %, preferably from 40 to 60 wt. % and in particular from 45 to 55 wt. %.

Particularly preferred washing or cleaning agent product forms contain at least one anionic surfactant as the surfactant.

The anionic surfactant is preferably selected from the group comprising C₉-C₁₃ alkylbenzene sulfonates, olefin sulfonates, C₁₂-C₁₈ alkane sulfonates, ester sulfonates, alk(en)yl sulfates, fatty alcohol ether sulfates and mixtures thereof. Compositions which comprise C₉-C₁₃ alkylbenzene sulfonates and fatty alcohol ether sulfates as the anionic surfactant have particularly good dispersing properties. In this case, preferably C₉-C₁₃ alkylbenzene sulfonates, olefin sulfonates, i.e. mixtures of alkene and hydroxyalkane sulfonates, and disulfonates, as obtained, for example, from C₁₂-C₁₈ monoolefins having a terminal or internal double bond by way of sulfonation with gaseous sulfur trioxide and subsequent alkaline or acid hydrolysis of the sulfonation products, are possible as surfactants of the sulfonate type. C₁₂-C₁₈ alkane sulfonates and the esters of α-sulfo fatty acids (ester sulfonates) are also suitable, for example the α-sulfonated methyl esters of hydrogenated coconut, palm kernel or tallow fatty acids.

The alkali salts and in particular the sodium salts of the sulfuric acid half-esters of C₁₂-C₁₈ fatty alcohols, for example from coconut fatty alcohol, tallow fatty alcohol, lauryl alcohol, myristyl alcohol, cetyl alcohol or stearyl alcohol, or of C₁₀-C₂₀ oxo alcohols and the half-esters of secondary alcohols having these chain lengths are preferred as alk(en)yl sulfates. From a washing perspective, C₁₂-C₁₆ alkyl sulfates, C₁₂-C₁₅ alkyl sulfates and C₁₄-C₁₅ alkyl sulfates are preferred. 2,3-alkyl sulfates are also suitable anionic surfactants.

The salts of the sulfuric acid half-esters of fatty alcohols having 12 to 18 C atoms, for example from coconut fatty alcohol, tallow fatty alcohol, lauryl alcohol, myristyl alcohol, cetyl alcohol or stearyl alcohol, or of the oxo alcohols having 10 to 20 C atoms and the half-esters of secondary alcohols having these chain lengths are preferred as alk(en)yl sulfates. From a washing perspective, the alkyl sulfates having 12 to 16 C atoms, alkyl sulfates having 12 to 15 C atoms and alkyl sulfates having 14 and 15 C atoms are preferred. 2,3-alkyl sulfates are also suitable anionic surfactants.

Fatty alcohol ether sulfates, such as the sulfuric acid monoesters of straight-chain or branched C₇-C₂₁ alcohols ethoxylated with 1 to 6 mol ethylene oxide, such as 2-methyl-branched C9-11 alcohols having, on average, 3.5 mol ethylene oxide (EO) or C12-18 fatty alcohols having 1 to 4 EO, are also suitable. Alkyl ether sulfates of formula (A-1) are preferred

R¹—O-(AO)ₙ—SO₃⁻X⁺ (A-1)

In this formula (A-1), R¹ represents a linear or branched, substituted or unsubstituted alkyl functional group, preferably a linear, unsubstituted alkyl functional group, particularly preferably a fatty alcohol functional group. Preferred functional groups R¹ of formula (A-1) are selected from decyl, undecyl, dodecyl, tridecyl, tetradecyl, pentadecyl, hexadecyl, heptadecyl, octadecyl, nonadecyl, eicosyl functional groups and mixtures thereof, the representatives having an even number of C atoms being preferred. Particularly preferred functional groups R¹ of formula (A-1) are derived from fatty alcohols having 12 to 18 C atoms, for example from coconut fatty alcohol, tallow fatty alcohol, lauryl alcohol, myristyl alcohol, cetyl alcohol or stearyl alcohol, or from oxo alcohols having 10 to 20 C atoms.

In formula (A-1), AO represents an ethylene oxide (EO) or propylene oxide (PO) group, preferably an ethylene oxide group. The index n in formula (A-1) is an integer of from 1 to 50, preferably from 1 to 20, and in particular from 2 to 10. Very particularly preferably, n is 2, 3, 4, 5, 6, 7 or 8. X is a monovalent cation or the nth part of an n-valent cation, the alkali metal ions, including Na⁺ or K⁺, being preferred in this case, with Na⁺ being most preferred. Further cations X+ may be selected from NH₄⁺, ½ Zn²⁺, ½ Mg²⁺, ½ Ca²⁺, ½ Mn²⁺ and the mixtures thereof, as well as primary and secondary amines, in particular monoethanolamine.

Particularly preferred washing or cleaning agent product forms contain an alkyl ether sulfate selected from fatty alcohol ether sulfates of formula A-2

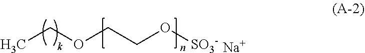

where k=11 to 19, and n=2, 3, 4, 5, 6, 7 or 8. Very particularly preferred representatives are Na fatty alcohol ether sulfates having 12 to 18 C atoms and 2 EO (k=11 to 13, n=2 in formula A-1). The degree of ethoxylation indicated represents a statistical average value which can be an integer or a fractional number for a specific product. The degrees of alkoxylation indicated represent statistical averages which can be an integer or a fractional number for a specific product. Preferred alkoxylates/ethoxylates have a narrowed homolog distribution (narrow range ethoxylates, NRE).

In a particularly preferred embodiment, the washing or cleaning agent product form contains C₉₋₁₃ alkylbenzene sulfonates and optionally also fatty alcohol ether sulfates as the anionic surfactant.

It is very particularly preferred for the washing or cleaning agent product form to contain at least one anionic surfactant of formula (A-3),

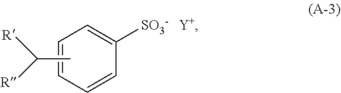

where
R′ and R″ are, independently of one another, H or alkyl, and together contain 9 to 19, preferably 9 to 15 and in particular 9 to 13, C atoms, and Y⁺ denotes a monovalent cation or the n-th part of an n-valent cation (in particular Na⁺).

In summary, preferred washing or cleaning agent product forms contain, as the surfactant, at least one anionic surfactant, preferably at least one anionic surfactant from the group consisting of C₈₋₁₈ alkylbenzene sulfonic acids, C₈₋₁₈ olefin sulfonic acids, C₁₂₋₁₈ alkane sulfonic acids, C₈₋₁₈ ester sulfonic acids, C₈₋₁₈ alkyl sulfates, C₈₋₁₈ alkenyl sulfates, fatty alcohol ether sulfates, in particular at least one anionic surfactant from the group of C₈₋₁₈ alkylbenzene sulfonic acids.

The proportion by weight of the anionic surfactant with respect to the total weight of the washing or cleaning agent product form is preferably 20 to 40 wt. % and in particular 25 to 35 wt. %.

The use of fatty acids has proven advantageous in regard to the stability of the washing or cleaning agent product forms. Preferred washing or cleaning agent product forms contain, based on their total weight, 4 to 12 wt. %, preferably 6 to 10 wt. %, fatty acid. Particularly preferred fatty acids are selected from the group of caprylic acid, capric acid, lauric acid, myristic acid, palmitic acid, stearic acid, oleic acid, linoleic acid and mixtures thereof. In the context of the application, the fatty acids are included in the group of anionic surfactants.

The detergent portion units contain non-ionic surfactant as a further preferred optional component. The proportion by weight of the non-ionic surfactant with respect to the total weight of the washing or cleaning agent product form is preferably 15 to 30 wt. % and in particular 20 to 30 wt. %. The use of non-ionic surfactants from the group of alkyl ethoxylates is particularly preferred.

Preferred alkyl ethoxylates are selected from the group of ethoxylated primary C₈₋₁₈ alcohols, preferably C₁₂₋₁₄ alcohols having 4 EO or 7 EO, C₉₋₁₁ alcohols having 7 EO, C₁₃₋₁₅ alcohols having 5 EO, 7 EO or 8 EO, C₁₃₋₁₅ oxo alcohols having 7 EO, C₁₂₋₁₈ alcohols having 5 EO or 7 EO, in particular C₁₂₋₁₈ fatty alcohols having 7 EO or C₁₃₋₁₅ oxo alcohols having 7 EO.

With regard to the processability and the cleaning effect of the washing or cleaning agent product form, it has proven to be advantageous to use non-ionic surfactant and anionic surfactant in the washing or cleaning agent product form in a weight ratio of from 3:1 to 1:2, preferably from 2:1 to 2:3 and in particular from 3:1 to 1:1.

A further group of preferred components of the washing or cleaning agent product form is made up of active washing or active cleaning polymers, which the washing or cleaning agent product form, based on the total weight thereof, contains, preferably in parts by weight of 2 to 15 wt. % and in particular of 4 to 12 wt. %.

The use of active washing or active cleaning polymers from the group of polyalkoxylated amines is particularly preferred.

Preferred washing or cleaning agent product forms contain, based on their total weight, 0.5 to 10 wt. %, preferably 1 to 8 wt. %, and in particular 3 to 6 wt. % polyalkoxylated amine. Corresponding weight portions have proven advantageous for the storage life, but in particular for the cleaning performance.

Preferred polyalkoxylated amines have a weight-average molecular weight M_{w} in the range from 1300 g/mol to 6000 g/mol, in particular from 1400 g/mol to 4500 g/mol. (The average molecular weights indicated here, and later possibly for other polymers, are weight-average molecular weights M_{w} which can in principle be determined by means of gel permeation chromatography with the aid of an R1 detector, the measurement expediently being carried out against an external standard.) For their preparation, it is possible to start, in a known manner, from ammonia, a monoalkylamine, a monoalkyl-monoalkanolamine or a monoalkyl-dialkanolamine or a monoalkanolamine, dialkanolamine or trialkanolamine, for example triethanolamine, methyl-, ethyl-, propyl- and isopropyl-diethanolamine, methyl-, ethyl-, propyl- and isopropyl-diisopropanolamine, tripropanolamine, triisopropanolamine, N,N-Di-(2-hydroxyethyl)cyclohexylamine, N,N-Di-(2-hydroxypropyl)cyclohexylamine, n-butylamine, n-hexylamine, n-octylamine, isopropylamine, sec-butylamine, tert-butylamine, cyclohexylamine, 2-ethylhexylamine, 2-phenylethylamine and mixtures thereof, which is reacted with an alkylene oxide, in particular selected from the group consisting of ethylene oxide, propylene oxide, butylene oxide and mixtures thereof, in particular with a mixture containing propylene oxide and preferably ethylene oxide, particularly preferably with propylene oxide. The polyalkoxylated amines thus obtainable may be block or random structures. Particular preference is given, inter alia, to a polyalkoxylated amine obtainable by propoxylation of triethanolamine, preferably having a length of the three side arms of 15 propylene oxide units in each case. Also preferred is a polyalkoxylated amine obtainable by propoxylation of triisopropanolamine, preferably having a length of the three side arms of 15 propylene oxide units in each case. Polyalkoxylated monoalkylamines having a linear, branched or cyclic alkyl group are likewise suitable, an alkylene oxide selected from the group consisting of ethylene oxide, propylene oxide, butylene oxide and mixtures thereof being alkoxylated, preferably with a mixture comprising propylene oxide, more preferably with propylene oxide. Preference is also given to a polyalkoxylated amine obtainable by propoxylation of tert-butylamine, preferably having a length of the two side arms of 12 propylene oxide units in each case.

Preferred polyalkoxylated amines satisfy the general formula (I),

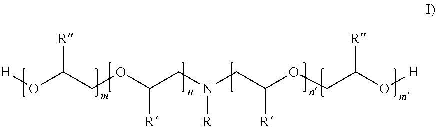

in which R represents a linear, optionally branched or optionally cyclic alkyl group having 1 to 12 C atoms or a —(CH₂CHR′O)ₙ—(CH₂CHR″O)_{m″}—H group,
R′ and R″, independently of one another, represent H, CH₃ or CH₂CH₃,
n, n′ and n″ represent, independently of one another, numbers from 0 to 30, preferably from 0 to 10 and in particular 0 to 5, and
m, m′ and m″ represent, independently of one another, numbers from 0 to 30, preferably from 5 to 20 and in particular from 12 to 16, with the proviso that the sum n+n′+n″+m+m′+m″ is at least 14, preferably in the range of from 18 to 100 and in particular in the range of from 20 to 70. Preferably, in the compounds of the formula I, at least one of the functional groups R′ and R″ is a CH₃ group.

Preference is furthermore given to the use of active washing or active cleaning polymers from the group of polyalkoxylated polyalkylene imines.

On the basis of their cleaning performance, preferred washing or cleaning agent product forms contain, based on their total weight, 0.5 to 5 wt. %, preferably 1 to 4 wt. %, and in particular 2 to 3 wt. % polyalkoxylated polyalkylene imine.

The polyalkoxylated polyalkylene imine is a polymer having a polyalkylene imine backbone which carries polyalkoxy groups on the N atoms. It preferably has a weight-average molecular weight Mw in the range from 5000 g/mol to 60000 g/mol, in particular from 10000 g/mol to 22500 g/mol. The polyalkylene imine has primary amino functions at the ends and preferably both secondary and tertiary amino functions in the interior, and optionally it can also have only secondary amino functions in the interior such that the result is not a branched-chain but a linear polyalkylene imine. The ratio of primary to secondary amino groups in the polyalkylene imine is preferably in the range from 1:0.5 to 1:1.5, in particular in the range from 1:0.7 to 1:1. The ratio of primary to tertiary amino groups in the polyalkylene imine is preferably in the range from 1:0.2 to 1:1, in particular in the range from 1:0.5 to 1:0.8. The polyalkylene imine preferably has a weight-average molecular weight in the range from 500 g/mol to 50000 g/mol, in particular from 550 g/mol to 2000 g/mol. The N atoms in the polyalkylene imine are preferably separated from one another by alkylene groups having 2 to 12 C atoms, in particular 2 to 6 C atoms, although it is not necessary for all the alkylene groups to have the same number of C atoms. Ethylene groups, 1,2-propylene groups, 1,3-propylene groups and mixtures thereof are particularly preferred. The primary amino functions in the polyalkylene imine can carry 1 or 2 polyalkoxy groups and the secondary amino functions can carry 1 polyalkoxy group, not every amino function having to be alkoxy group-substituted. The average number of alkoxy groups per primary and secondary amino function in the polyalkoxylated polyalkylenimine is preferably 5 to 100, in particular 10 to 50. The alkoxy groups in the polyalkoxylated polyalkylene imine are preferably ethoxy, propoxy or butoxy groups or mixtures thereof. Polyethoxylated polyethyleneimines are particularly preferred. The polyalkoxylated polyalkylene imines are obtainable by reacting the polyalkylene imines with epoxides corresponding to the alkoxy groups. If desired, the terminal OH function of at least some of the polyalkoxy substituents can be replaced by an alkyl ether function having 1 to 10, in particular 1 to 3, C atoms.

In summary, washing or cleaning agent product forms are preferred which contain an active washing or active cleaning polymer from the group of
i) polyalkoxylated amines having a weight-average molecular weight M_{w} in the range from 600 g/mol to 10000 g/mol, which are obtainable by reacting ammonia or primary alkyl or hydroxyalkylamines having a molecular weight of less than 200 g/mol with alkylene oxides; and/or
ii) polyalkoxylated polyalkylene imine, which are obtainable by reacting polyalkylene imines with alkylene oxides.

Preferred washing or cleaning agent product forms contain, based on their total weight, 0.2 to 8 wt. %, preferably 0.5 to 6 wt. %, enzyme preparation.

In addition to the actual enzyme protein, an enzyme preparation comprises further components such as enzyme stabilizers, carrier materials or fillers. In this case, the enzyme protein typically forms only a fraction of the total weight of the enzyme preparation. Enzyme preparations which are preferably used contain between 0.1 and 40 wt. %, preferably between 0.2 and 30 wt. %, more preferably between 0.4 and 20 wt. %, and most preferably between 0.8 and 10 wt. % of the enzyme protein. Such compositions can contain an enzyme stabilizer in an amount of 0.05 to 35 wt. %, preferably 0.05 to 10 wt. %, based on the total weight in the enzyme composition.

The protein concentration can be determined using known methods, for example the BCA method (bicinchoninic acid; 2,2′-bichinolyl-4,4′-dicarboxylic acid) or the Biuret method. In this regard, the active protein concentration is determined by means of titration of the active centers using a suitable irreversible inhibitor (for proteases, for example, phenylmethylsulfonyl fluoride (PMSF)) and determination of the residual activity (cf. M. Bender et al., J. Chem. Soc. 88, 24 (1966), p. 5890-5913).

For the manufacturability and the subsequent dissolving capability of the washing or cleaning agent product form, it has proven to be advantageous if it, based on the total weight thereof, 15 to 35 wt. %, preferably 20 to 30 wt. %, of an aqueous-organic solvent.

Preferred organic solvents are selected from the group of ethanol, n-propanol, i-propanol, butanols, glycol, propanediol, butanediol, methylpropanediol, glycerol, diglycol, propyl diglycol, butyl diglycol, hexylene glycol, ethylene glycol methyl ether, ethylene glycol ethyl ether, ethylene glycol propyl ether, ethylene glycol mono-n-butyl ether, diethylene glycol methyl ether, diethylene glycol ethyl ether, propylene glycol methyl ether, propylene glycol ethyl ether, propylene glycol propyl ether, dipropylene glycol mono methyl ether, dipropylene glycol mono ethyl ether, methoxytriglycol, ethoxytriglycol, butoxytriglycol, 1-butoxyethoxy-2-propanol, 3-methyl-3-methoxybutanol, propylene-glycol-t-butyl ether, di-n-octyl ether and mixtures thereof, preferably from the group of propanediol, glycerol, monoethanolamine, and mixtures thereof. The proportion by weight of the organic solvent with respect to the total weight of the washing or cleaning agent product form, based on the total weight thereof, is preferably from 5 to 30 wt. %, in particular from 10 to 25 wt. %.

In addition to organic solvents, the washing or cleaning agent product forms can contain water as an additional liquid carrier. The water content of preferred washing or cleaning agent product forms is 5 to 18 wt. %, in particular 7 to 15 wt. %, based on the total weight thereof.

The washing or cleaning agent product form contains phosphonate as a preferred optional component. The proportion by weight of phosphonate with respect to the total weight of the washing or cleaning agent product form is preferably 0.1 to 3 wt. % and in particular 0.2 to 2 wt. %.

A phosphonate from the group of hydroxyalkane phosphonates and/or aminoalkane phosphonates, preferably from the group of aminoalkane phosphonates, and in particular from the group of ethylenediamine tetramethylene phosphonate (EDTMP) and diethylenetriamine pentamethylene phosphonate (DTPMP), in particular from the group diethylenetriamine pentamethylene phosphonate (DTPMP), is preferably selected as the phosphonate compound.

As a further preferred optional component, the washing or cleaning agent product form, based on the total weight thereof, comprises 0.2 to 4 wt. %, preferably 0.5 to 3 wt. %, fragrance preparation.

In addition to the actual fragrances, the fragrance preparation comprises solvents, solid carrier materials or stabilizers, for example.

A fragrance is a chemical substance that stimulates the sense of smell. In order to be able to stimulate the sense of smell, the chemical substance should be able to be distributed in the air, at least in part, i.e., the fragrance should be volatile at 25° C., at least to a small degree. If the fragrance is very volatile, the odor intensity then decreases rapidly again. In the case of a lower volatility, however, the odor impression is more sustainable, i.e., it does not disappear as quickly. In one embodiment, the fragrance therefore has a melting point which is in the range from −100° C. to 100° C., preferably from −80° C. to 80° C., more preferably from −20° C. to 50° C., in particular from −30° C. to 20° C. In a further embodiment, the fragrance has a boiling point in the range from 25° C. to 400° C., preferably from 50° C. to 380° C., more preferably from 75° C. to 350° C., in particular from 100° C. to 330° C.

Overall, a chemical substance should not exceed a particular molecular mass in order to act as a fragrance, since the required volatility can no longer be ensured at too high a molecular mass. In one embodiment, the fragrance has a molecular mass of 40 to 700 g/mol, more preferably of 60 to 400 g/mol.

The odor of a fragrance is perceived as pleasant by most people, and frequently corresponds to the odor of, for example, flowers, fruits, spices, bark, resin, leaves, grasses, mosses and roots. Thus, fragrances can also be used to mask unpleasant odors or else to provide a non-smelling substance with a desired odor. Individual fragrance compounds, for example the synthetic products of the ester, ether, aldehyde, ketone, alcohol and hydrocarbon types, can be used as fragrances.

Preferably, mixtures of different fragrances are used, which together produce an attractive fragrance note. Such a mixture of fragrances can also be referred to as perfume or perfume oil. Perfume oils of this kind can also contain natural fragrance mixtures, as are obtainable from plant sources.

For the lengthening of the fragrance effect, it has proven advantageous to encapsulate the fragrance. In a corresponding embodiment, at least a portion of the fragrance is used in encapsulated form (fragrance capsules), in particular in microcapsules. However, the entire fragrance can also be used in encapsulated form. The microcapsules may be water-soluble and/or water-insoluble microcapsules. For example, melamine-urea-formaldehyde microcapsules, melamine-formaldehyde microcapsules, urea-formaldehyde microcapsules or starch microcapsules can be used. “Fragrance precursor” refers to compounds which release the actual fragrance only after chemical conversion/cleavage, typically by the action of light or other ambient conditions, such as pH, temperature, etc. Such compounds are often also referred to as “pro-fragrances”.

Preferred washing or cleaning agent product forms further contain dye.

The composition of some preferred washing or cleaning agent product forms can be derived from the following tables (amounts given in wt. % based on the total weight of the preparation, unless otherwise indicated).

| | | | | Formula |
|---|---|---|---|---|
| | Formula 1 | Formula 2 | Formula 3 | 4 |
| Low-molecular-weight gelling agent¹⁾ | 0.01 to | 0.1 to | 0.1 | 1 |
| | 15 | 10 | to 10 | to 4 |
| Compound of formula (I)²⁾ | 0.5 to | 0.5 to | 1 | 1 |
| | 10 | 10 | to 8 | to 8 |
| Active washing or active cleaning | 30 to | 30 to | 40 | 50 |
| substance | 80 | 80 | to 75 | to 70 |
| Misc. | up to | up to | up | up |
| | 100 | 100 | to 100 | to 100 |
| | Formula 6 | Formula 7 | Formula 8 | Formula 9 |
| Low-molecular-weight gelling | 0.01 to | 0.1 | 0.1 | 1 |
| agent¹⁾ | 15 | to 10 | to 10 | to 4 |
| Compound of formula (I)²⁾ | 0.5 to | 0.5 | 1 | 1 |
| | 10 | to 10 | to 8 | to 8 |
| Surfactant | 30 to 70 | 40 | 40 | 45 |
| | | to 60 | to 60 | to 55 |
| Misc. | up to | up | up | up |
| | 100 | to 100 | to 100 | to 100 |
| | | | Formula | Formula |
| | Formula 11 | Formula 12 | 13 | 14 |
| Low-molecular-weight gelling | 0.01 to | 0.1 | 0.1 | 1 |
| agent¹⁾ | 15 | to 10 | to 10 | to 4 |
| Compound of formula (I)²⁾ | 0.5 to | 0.5 | 1 | 1 |
| | 10 | to 10 | to 8 | to 8 |
| Anionic surfactant | 20 to 40 | 20 | 25 | 25 |
| | | to 40 | to 35 | to 35 |
| Non-ionic surfactant | 15 to 30 | 15 | 20 | 20 |
| | | to 30 | to 30 | to 30 |
| Misc. | up to | up | up | up |
| | 100 | to 100 | to 100 | to 100 |
| | | | Formula | Formula |
| | Formula 16 | Formula 17 | 18 | 19 |
| Low-molecular-weight gelling | 0.01 to | 0.1 | 0.1 | 1 |
| agent¹⁾ | 15 | to 10 | to 10 | to 4 |
| Compound of formula (I)²⁾ | 0.5 to 10 | 0.5 | 1 to | 1 |
| | | to 10 | 8 | to 8 |
| Anionic surfactant | 20 to 40 | 20 | 25 | 25 |
| of which fatty acid | | to 40 | to 35 | to 35 |
| | 4 to 12 | 4 to | 6 to | 6 |
| | | 12 | 10 | to 10 |
| Non-ionic surfactant | 15 to 30 | 15 | 20 | 20 |
| | | to 30 | to 30 | to 30 |
| Misc. | up to 100 | up | up | up |
| | | to 100 | to 100 | to 100 |
| | | | Formula | Formula |
| | Formula 21 | Formula 22 | 23 | 24 |
| Low-molecular-weight gelling | 0.01 to | 0.1 to | 0.1 | 1 to |
| agent¹⁾ | 15 | 10 | to 10 | 4 |
| Compound of formula (I)²⁾ | 0.5 to | 0.5 to | 1 | 1 to |
| | 10 | 10 | to 8 | 8 |
| Surfactant | 30 to 70 | 40 to | 40 | 45 |
| | | 60 | to 60 | to 55 |
| Enzyme preparation | 0.2 to 8 | 0.2 to | 0. | 0.5 |
| | | 8 | 5 to 6 | to 6 |
| Misc. | up to | up to | up | up |
| | 100 | 100 | to 100 | to 100 |
| | | | Formula | Formula |
| | Formula 26 | Formula 27 | 28 | 29 |
| Low-molecular-weight gelling | 0.01 to | 0.1 to | 0.1 | 1 to |
| agent¹⁾ | 15 | 10 | to 10 | 4 |
| Compound of formula (I)²) | 0.5 to | 0.5 to | 1 | 1 to |
| | 10 | 10 | to 8 | 8 |
| Surfactant | 30 to 70 | 40 to | 40 | 45 |
| | | 60 | to 60 | to 55 |
| Active washing or active cleaning | 2 to 15 | 2 to | 4 | 4 to |
| polymer | | 15 | to 12 | 12 |
| Misc. | up to | up to | up | up |
| | 100 | 100 | to 100 | to 100 |
| | | | Formula | Formula |
| | Formula 31 | Formula 32 | 33 | 34 |
| Low-molecular-weight gelling | 0.01 to | 0.1 to | 0.1 | 1 to |
| agent¹⁾ | 15 | 10 | to 10 | 4 |
| Compound of formula (I)²⁾ | 0.5 to | 0.5 to | 1 | 1 to |
| | 10 | 10 | to 8 | 8 |
| Anionic surfactant | 20 to 40 | 20 to | 25 | 25 |
| | | 40 | to 35 | to 35 |
| Non-ionic surfactant | 15 to 30 | 15 to | 20 | 20 |
| | | 30 | to 30 | to 30 |
| Aqueous-organic solvent | 15 to 35 | 15 to | 20 | 20 |
| | | 35 | to 30 | to 30 |
| Misc. | up to | up to | up | up |
| | 100 | 100 | to 100 | to 100 |
| | | | Formula | Formula |
| | Formula 36 | Formula 37 | 38 | 39 |
| Low-molecular-weight gelling | 0.01 to | 0.1 to | 0.1 | 1 to |
| agent¹⁾ | 15 | 10 | to 10 | 4 |
| Compound of formula (I)²⁾ | 0.5 to | 0.5 to | 1 | 1 to |
| | 10 | 10 | to 8 | 8 |
| Anionic surfactant | 20 to 40 | 20 to | 25 | 25 |
| | | 40 | to 35 | to 35 |
| Non-ionic surfactant | 15 to 30 | 15 to | 20 | 20 |
| | | 30 | to 30 | to 30 |
| Enzyme preparation | 0.2 to 8 | 0.2 to | 0.5 | 0.5 |
| | | 8 | to 6 | to 6 |
| Aqueous-organic solvent | 15 to 35 | 15 to | 20 | 20 |
| | | 35 | to 30 | to 30 |
| Misc. | up to | up to | up | up |
| | 100 | 100 | to 100 | to 100 |
| | | | Formula | Formula |
| | Formula 41 | Formula 42 | 43 | 44 |
| Low-molecular-weight gelling | 0.01 to | 0.1 to | 0.1 | 1 to |
| agent¹⁾ | 15 | 10 | to 10 | 4 |
| Compound of formula (I)²⁾ | 0.5 to | 0.5 to | 1 | 1 to |
| | 10 | 10 | to 8 | 8 |
| Anionic surfactant | 20 to 40 | 20 to | 25 | 25 |
| | | 40 | to 35 | to 35 |
| Non-ionic surfactant | 15 to 30 | 15 to | 20 | 20 |
| | | 30 | to 30 | to 30 |
| Enzyme preparation | 0.2 to 8 | 0.2 to | 0.5 | 0.5 |
| | | 8 | to 6 | to 6 |
| Active washing or active cleaning | 2 to 15 | 2 to | 4 | 4 to |
| polymer | | 15 | to 12 | 12 |
| Aqueous-organic solvent | 15 to 35 | 15 to | 20 | 20 |
| | | 35 | to 30 | to 30 |
| Misc. | up to | up to | up | up |
| | 100 | 100 | to 100 | to 100 |
| | | | Formula | Formula |
| | Formula 46 | Formula 47 | 48 | 49 |
| Low-molecular-weight gelling | 0.01 to | 0.1 to | 0.1 | 1 to |
| agent³⁾ | 15 | 10 | to 10 | 4 |
| A compound of formula (I)²⁾ | 0.5 to | 0.5 to | 1 | 1 to |
| | 10 | 10 | to 8 | 8 |
| Active washing or active | 30 to 80 | 30 to | 40 | 50 |
| cleaning substance | | 80 | to 75 | to 70 |
| Misc. | up to | up to | up | up |
| | 100 | 100 | to 100 | to 100 |
| | | | Formula | Formula |
| | Formula 51 | Formula 52 | 53 | 54 |
| Low-molecular-weight gelling | 0.01 to | 0.1 to | 0.1 | 1 to |
| agent³⁾ | 15 | 10 | to 10 | 4 |
| Compound of formula (I)²⁾ | 0.5 to | 0.5 to | 1 | 1 to |
| | 10 | 10 | to 8 | 8 |
| Surfactant | 30 to 70 | 40 to | 40 | 45 |
| | | 60 | to 60 | to 55 |
| Misc. | up to | up to | up | up |
| | 100 | 100 | to 100 | to 100 |
| | | | Formula | Formula |
| | Formula 56 | Formula 57 | 58 | 59 |
| Low-molecular-weight gelling | 0.01 to | 0.1 to | 0.1 | 1 to |
| agent³⁾ | 15 | 10 | to 10 | 4 |
| Compound of formula (I)²⁾ | 0.5 to | 0.5 to | 1 | 1 to |
| | 10 | 10 | to 8 | 8 |
| Anionic surfactant | 20 to 40 | 20 to | 25 | 25 |
| | | 40 | to 35 | to 35 |
| Non-ionic surfactant | 15 to 30 | 15 to | 20 | 20 |
| | | 30 | to 30 | to 30 |
| Misc. | up to | up to | up | up |
| | 100 | 100 | to 100 | to 100 |
| | | | Formula | Formula |
| | Formula 61 | Formula 62 | 63 | 64 |
| Low-molecular-weight gelling | 0.01 to | 0.1 to | 0.1 | 1 to |
| agent³⁾ | 15 | 10 | to 10 | 4 |
| Compound of formula (I)²⁾ | 0.5 to | 0.5 to | 1 | 1 to |
| | 10 | 10 | to 8 | 8 |
| Anionic surfactant | 20 to 40 | 20 to | 25 | 25 |
| of which fatty acid | | 40 | to 35 | to 35 |
| | 4 to 12 | 4 to | 6 | 6 to |
| | | 12 | to 10 | 10 |
| Non-ionic surfactant | 15 to 30 | 15 to | 20 | 20 |
| | | 30 | to 30 | to 30 |
| Misc. | up to | up to | up | up |
| | 100 | 100 | to 100 | to 100 |
| | | | Formula | Formula |
| | Formula 66 | Formula 67 | 68 | 69 |
| Low-molecular-weight gelling | 0.01 to | 0.1 to | 0.1 | 1 to |
| agent³⁾ | 15 | 10 | to 10 | 4 |
| Compound of formula (I)²⁾ | 0.5 to | 0.5 to | 1 | 1 to |
| | 10 | 10 | to 8 | 8 |
| Surfactant | 30 to 70 | 40 to | 40 | 45 |
| | | 60 | to 60 | to 55 |
| Enzyme preparation | 0.2 to 8 | 0.2 to | 0.5 | 0.5 |
| | | 8 | to 6 | to 6 |
| Misc. | up to | up to | up | up |
| | 100 | 100 | to 100 | to 100 |
| | Formula | Formula | Formula | Formula |
| | 71 | 72 | 73 | 74 |
| Low-molecular-weight gelling | 0.01 to | 0.1 to | 0.1 | 1 to |
| agent³⁾ | 15 | 10 | to 10 | 4 |
| Compound of formula (I)²⁾ | 0.5 to | 0.5 to | 1 | 1 to |
| | 10 | 10 | to 8 | 8 |
| Surfactant | 30 to 70 | 40 to | 40 | 45 |
| | | 60 | to 60 | to 55 |
| Active washing or active | 2 to 15 | 2 to | 4 | 4 to |
| cleaning polymer | | 15 | to 12 | 12 |
| Misc. | up to | up to | up | up |
| | 100 | 100 | to 100 | to 100 |
| | Formula | | Formula | Formula |
| | 76 | Formula 77 | 78 | 79 |
| Low-molecular-weight gelling | 0.01 to | 0.1 to | 0.1 | 1 to |
| agent³⁾ | 15 | 10 | to 10 | 4 |
| A compound of formula (I)²⁾ | 0.5 to | 0.5 to | 1 | 1 to |
| | 10 | 10 | to 8 | 8 |
| Anionic surfactant | 20 to 40 | 20 to | 25 | 25 |
| | | 40 | to 35 | to 35 |
| Non-ionic surfactant | 15 to 30 | 15 to | 20 | 20 |
| | | 30 | to 30 | to 30 |
| Aqueous-organic solvent | 15 to 35 | 15 to | 20 | 20 |
| | | 35 | to 30 | to 30 |
| Misc. | up to | up to | up | up |
| | 100 | 100 | to 100 | to 100 |
| | | | Formula | Formula |
| | Formula 81 | Formula 82 | 83 | 84 |
| Low-molecular-weight gelling | 0.01 to | 0.1 to | 0.1 | 1 to |
| agent³⁾ | 15 | 10 | to 10 | 4 |
| Compound of formula (I)²⁾ | 0.5 to | 0.5 to | 1 | 1 to |
| | 10 | 10 | to 8 | 8 |
| Anionic surfactant | 20 to 40 | 20 to | 25 | 25 |
| | | 40 | to 35 | to 35 |
| Non-ionic surfactant | 15 to 30 | 15 to | 20 | 20 |
| | | 30 | to 30 | to 30 |
| Enzyme preparation | 0.2 to 8 | 0.2 to | 0.5 | 0.5 |
| | | 8 | to 6 | to 6 |
| Aqueous-organic solvent | 15 to 35 | 15 to | 20 | 20 |
| | | 35 | to 30 | to 30 |
| Misc. | up to | up to | up | up |
| | 100 | 100 | to 100 | to 100 |
| | | | Formula | Formula |
| | Formula 86 | Formula 87 | 88 | 89 |
| Low-molecular-weight gelling | 0.01 to | 0.1 to | 0.1 | 1 to |
| agent³⁾ | 15 | 10 | to 10 | 4 |
| Compound of formula (I)²⁾ | 0.5 to | 0.5 to | 1 | 1 to |
| | 10 | 10 | to 8 | 8 |
| Anionic surfactant | 20 to 40 | 20 to | 25 | 25 |
| | | 40 | to 35 | to 35 |
| Non-ionic surfactant | 15 to 30 | 15 to | 20 | 20 |
| | | 30 | to 30 | to 30 |
| Enzyme preparation | 0.2 to 8 | 0.2 to | 0.5 | 0.5 |
| | | 8 | to 6 | to 6 |
| Active washing or active | 2 to 15 | 2 to | 4 | 4 to |
| cleaning polymer | | 15 | to 12 | 12 |
| Aqueous-organic solvent | 15 to 35 | 15 to | 20 | 20 |
| | | 35 | to 30 | to 30 |
| Misc. | up to | up to | up | up |
| | 100 | 100 | to 100 | to 100 |
| | | | Formula | Formula |
| | Formula 91 | Formula 92 | 93 | 94 |
| Low-molecular-weight gelling | 0.01 to | 0.1 to | 0.1 | 1 to |
| agent3) | 15 | 10 | to 10 | 4 |
| Compound of formula (I)4) | 0.5 to | 0.5 to | 1 | 1 to |
| | 10 | 10 | to 8 | 8 |
| Active washing or active cleaning | 30 to 80 | 30 to | 40 | 50 |
| substance | | 80 | to 75 | to 70 |
| Misc. | up to | up to | up | up |
| | 100 | 100 | to 100 | to 100 |
| | | | Formula | Formula |
| | Formula 96 | Formula 97 | 98 | 99 |
| Low-molecular-weight gelling | 0.01 to | 0.1 to | 0.1 | 1 to |
| agent³⁾ | 15 | 10 | to 10 | 4 |
| A compound of formula (I)⁴⁾ | 0.5 to | 0.5 to | 1 | 1 to |
| | 10 | 10 | to 8 | 8 |
| Surfactant | 30 to 70 | 40 to | 40 | 45 |
| | | 60 | to 60 | to 55 |
| Misc. | up to | up to | up | up |
| | 100 | 100 | to 100 | to 100 |
| | | | Formula | Formula |
| | Formula 101 | Formula 102 | 103 | 104 |
| Low-molecular-weight gelling | 0.01 to | 0.1 to | 0.1 | 1 to |
| agent³⁾ | 15 | 10 | to 10 | 4 |
| Compound of formula (I)⁴⁾ | 0.5 to | 0.5 to | 1 | 1 to |
| | 10 | 10 | to 8 | 8 |
| Anionic surfactant | 20 to 40 | 20 to | 25 | 25 |
| | | 40 | to 35 | to 35 |
| Non-ionic surfactant | 15 to 30 | 15 to | 20 | 20 |
| | | 30 | to 30 | to 30 |
| Misc. | up to | up to | up | up |
| | 100 | 100 | to 100 | to 100 |
| | | | Formula | Formula |
| | Formula 106 | Formula 107 | 108 | 109 |
| Low-molecular-weight gelling | 0.01 to | 0.1 to | 0.1 | 1 to |
| agent³⁾ | 15 | 10 | to 10 | 4 |
| Compound of formula (I)⁴⁾ | 0.5 to | 0.5 to | 1 | 1 to |
| | 10 | 10 | to 8 | 8 |
| Anionic surfactant | 20 to 40 | 20 to | 25 | 25 |
| of which fatty acid | | 40 | to 35 | to 35 |
| | 4 to 12 | 4 to | 6 | 6 to |
| | | 12 | to 10 | 10 |
| Non-ionic surfactant | 15 to 30 | 15 to | 20 | 20 |
| | | 30 | to 30 | to 30 |
| Misc. | up to | up to | up | up |
| | 100 | 100 | to 100 | to 100 |
| | | | Formula | Formula |
| | Formula 111 | Formula 112 | 113 | 114 |
| Low-molecular-weight gelling | 0.01 to | 0.1 to | 0.1 | 1 to |
| agent³⁾ | 15 | 10 | to 10 | 4 |
| Compound of formula (I)⁴⁾ | 0.5 to | 0.5 to | 1 | 1 to |
| | 10 | 10 | to 8 | 8 |
| Surfactant | 30 to 70 | 40 to | 40 | 45 |
| | | 60 | to 60 | to 55 |
| Enzyme preparation | 0.2 to 8 | 0.2 to | 0.5 | 0.5 |
| | | 8 | to 6 | to 6 |
| Misc. | up to | up to | up | up |
| | 100 | 100 | to 100 | to 100 |
| | | | Formula | Formula |
| | Formula 116 | Formula 117 | 118 | 119 |
| Low-molecular-weight gelling | 0.01 to | 0.1 to | 0.1 | 1 |
| agent³⁾ | 15 | 10 | to 10 | to 4 |
| Compound of formula (I)⁴⁾ | 0.5 to | 0.5 to | 1 | 1 |
| | 10 | 10 | to 8 | to 8 |
| Surfactant | 30 to 70 | 40 to | 40 | 45 |
| | | 60 | to 60 | to 55 |
| Active washing or active | 2 to 15 | 2 to | 4 | 4 |
| cleaning polymer | | 15 | to 12 | to 12 |
| Misc. | up to | up to | up | up |
| | 100 | 100 | to 100 | to 100 |
| | | | Formula | Formula |
| | Formula 121 | Formula 122 | 123 | 124 |
| Low-molecular-weight gelling | 0.01 to | 0.1 to | 0.1 | 1 |
| agent³⁾ | 15 | 10 | to 10 | to 4 |
| Compound of formula (I)⁴⁾ | 0.5 to | 0.5 to | 1 | 1 |
| | 10 | 10 | to 8 | to 8 |
| Anionic surfactant | 20 to 40 | 20 to | 25 | 25 |
| | | 40 | to 35 | to 35 |
| Non-ionic surfactant | 15 to 30 | 15 to | 20 | 20 |
| | | 30 | to 30 | to 30 |
| Aqueous-organic solvent | 15 to 35 | 15 to | 20 | 20 |
| | | 35 | to 30 | to 30 |
| Misc. | up to | up to | up | up |
| | 100 | 100 | to 100 | to 100 |
| | | | Formula | Formula |
| | Formula 126 | Formula 127 | 128 | 129 |
| Low-molecular-weight gelling | 0.01 to | 0.1 to | 0.1 | 1 |
| agent³⁾ | 15 | 10 | to 10 | to 4 |
| Compound of formula (I)⁴⁾ | 0.5 to | 0.5 to | 1 | 1 |
| | 10 | 10 | to 8 | to 8 |
| Anionic surfactant | 20 to 40 | 20 to | 25 | 25 |
| | | 40 | to 35 | to 35 |
| Non-ionic surfactant | 15 to 30 | 15 to | 20 | 20 |
| | | 30 | to 30 | to 30 |
| Enzyme preparation | 0.2 to 8 | 0.2 to | 0.5 | 0.5 |
| | | 8 | to 6 | to 6 |
| Aqueous-organic solvent | 15 to 35 | 15 to | 20 | 20 |
| | | 35 | to 30 | to 30 |
| Misc. | up to | up to | up | up |
| | 100 | 100 | to 100 | to 100 |
| | | | Formula | Formula |
| | Formula 131 | Formula 132 | 133 | 134 |
| Low-molecular-weight gelling | 0.01 | 0.1 | 0.1 to 10 | 1 |
| agent³⁾ | to 15 | to 10 | | to 4 |
| Compound of formula (I)⁴⁾ | 0.5 | 0.5 | 1 to 8 | 1 |
| | to 10 | to 10 | | to 8 |
| Anionic surfactant | 20 | 20 | 25 to 35 | 25 |
| | to 40 | to 40 | | to 35 |
| Non-ionic surfactant | 15 | 15 | 20 to 30 | 20 |
| | to 30 | to 30 | | to 30 |
| Enzyme preparation | 0.2 | 0.2 | 0.5 to 6 | 0.5 |
| | to 8 | to 8 | | to 6 |
| Active washing or active cleaning | 2 | 2 to | 4 to 12 | 4 |
| polymer | to 15 | 15 | | to 12 |
| Aqueous-organic solvent | 15 | 15 | 20 to 30 | 20 |
| | to 35 | to 35 | | to 30 |
| Misc. | up | up | up to 100 | up |
| | to 100 | to 100 | | to 100 |

¹⁾Low-molecular-weight gelling agent having a molar mass of up to 2000 g/mol
²⁾Compound of the general formula (I) 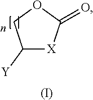
where
X represents a methylene group or oxygen atom;
Y represents a hydrogen atom or a methyl group;
n represents a number from 1 to 3.
³⁾dibenzylidene sorbitol
⁴⁾Compound of the general formula (I) 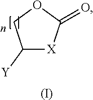
where
X represents a methylene group;
Y represents a hydrogen atom;
n represents a number from 1 to 3.

The previously described material systems are not only suitable for ensuring simple producibility, a good storage life and cleaning performance, but also enable the realization of product optics which are attractive to the consumer. For example, washing or cleaning agent product forms which are transparent and consequently have low turbidity are perceived as optically attractive. Preferred washing or cleaning agent product forms therefore have a turbidity (HACH Turbidimeter 2100Q, 20° C., 10 ml cuvette) below 100 NTU, preferably below 50 NTU, and in particular below 20 NTU. In the case of an NTU value (at 20° C.) of 60 or more, molded bodies exhibit a perceptible turbidity, within the meaning of the invention, identifiable by the naked eye.

The optical advantages of the washing or cleaning agent product forms take effect in particular in packaging means, which are in turn transparent and enable a direct view of the washing or cleaning agent product forms. In addition to transparent plastic bottles, transparent bags, in particular water-soluble transparent bags, are therefore preferred for manufacturing and packaging.

The washing or cleaning agent product forms are preferably dimensionally stable. Bodies are considered dimensionally stable if they have an inherent dimensional stability that enables them to assume a non-disintegrating three-dimensional shape under the usual conditions of manufacture, storage, transport and handling by the consumer, this three-dimensional shape also not changing under the conditions mentioned over an extended period of time, preferably 4 weeks, particularly preferably 8 weeks and in particular 32 weeks, i.e., under the usual conditions of manufacture, storage, transport and handling by the consumer, the body remains in the three-dimensional geometric shape created during manufacture, i.e., it does not dissolve.

The washing or cleaning agent product form can be packaged in different ways known to a person skilled in the art. The washing or cleaning agent product forms are preferably packaged as gel bodies. Bodies which exhibit elastic deformation behavior under the action of force are referred to as gel bodies.

Furthermore, it is preferred to execute the washing or cleaning agent product form in the form of a portion unit, preferably as a portion unit having a weight of from 5 to 30 g, preferably from 8 to 22 g. Corresponding portion units enable simplified metering, for example into the metering chamber of a washing machine or a dishwasher.

As stated above, the washing or cleaning agent product form is suitable for the packaging of active washing or active cleaning substances. Corresponding washing or cleaning agent product forms are therefore used in particular in textile washing methods or methods for cleaning hard surfaces.

Further subject matter of the applications is, for this reason,
a method for washing textiles, in the course of which a washing or cleaning agent product form according to any one of the preceding points is introduced into a washing liquor
a method for cleaning hard surfaces, in the course of which a washing or cleaning agent product form according to any one of the preceding points is introduced into a cleaning liquor.

This application further relates to a method for producing a washing or cleaning agent product form, comprising the steps of
i) providing a solution of at least one low-molecular-weight gelling agent having a molar mass of up to 2000 g/mol in at least one compound of general formula (I)

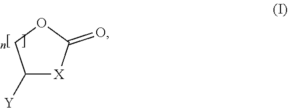

where
X represents a methylene group or an oxygen atom
Y represents a hydrogen atom or a methyl group
n represents a number from 1 to 3;
   ii) providing at least one active washing or active cleaning substance;
   iii) mixing the solution i) and the active substance ii) to form an active substance-containing mixture;
   iv) optionally solidifying the active substance-containing mixture.

In summary, the following subjects, inter alia, are provided by this application:
1. A gel-like washing or cleaning agent product form, containing
   a) at least one low-molecular-weight gelling agent having a molar mass of up to 2000 g/mol
   b) at least one compound of general formula (I)

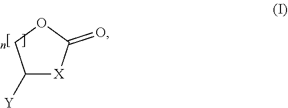

where
   X represents a methylene group or an oxygen atom
   Y represents a hydrogen atom or a methyl group
   n represents a number from 1 to 3;
   c) at least one active washing or active cleaning agent.
2. The washing or cleaning agent product form according to point 1, wherein the low-molecular-weight gelling agent has a molar mass of 200 g/mol to 2000 g/mol, preferably of 200 g/mol to 1000 g/mol.
3. The washing or cleaning agent product form according to any of the preceding points, wherein the washing or cleaning agent product form, based on the total weight thereof, has a proportion by weight of low-molecular-weight gelling agent a) of from 0.01 to 15 wt. %, preferably from 0.1 to 10 wt. %, and in particular from 1 to 4 wt. %.
4. The washing or cleaning agent product form according to any of the preceding points, wherein the low-molecular-weight gelling agent a) is selected from the group of cyclic dipeptides, cyclic dipeptide derivatives and dibenzylidene sorbitols and mixtures thereof.
5. The washing or cleaning agent product form according to any of the preceding points, wherein the low-molecular-weight gelling agent is selected from the group dibenzylidene sorbitol.
6. The washing or cleaning agent product form according to any of the preceding points, wherein, in the general formula (I),
   X represents a methylene group
   Y represents a hydrogen atom
   n represents a number from 1 to 3.
7. The washing or cleaning agent product form according to any of the preceding points, wherein, in the general formula (I),
   X represents a methylene group
   Y represents a hydrogen atom
   n is 2.
8. The washing or cleaning agent product form according to any of the preceding points, wherein, in the general formula (I),
   X represents an oxygen atom
   Y represents a hydrogen atom or a methyl group
   n is 1.
9. The washing or cleaning agent product form according to any of the preceding points, wherein the washing or cleaning agent product form contains two, three or more compounds of the general formula (I).
10. The washing or cleaning agent product form according to any of the preceding points, wherein the washing or cleaning agent product form contains, based on the total weight thereof, 0.5 to 10 wt. %, preferably 1.0 to 8 wt. %, of the compound of general formula (I).
11. The washing or cleaning agent product form according to any of the preceding points, wherein the washing or cleaning agent product form contains, based on the total weight thereof, 30 to 80 wt. %, preferably 40 to 75 wt. % and in particular 50 to 70 wt. %, active washing or active cleaning substance.
12. The washing or cleaning agent product form according to any of the preceding points, wherein the active washing or active cleaning substance is selected from the group of surfactants, enzymes, active washing or active cleaning polymers, complexing agents, and fragrance preparations.
13. The washing or cleaning agent product form according to any of the preceding points, wherein the washing or cleaning agent product form contains, based on the total weight thereof, 30 to 70 wt. %, preferably 40 to 60 wt. % and in particular 45 to 55 wt. %, surfactant.
14. The washing or cleaning agent product form according to any of the preceding points, wherein the washing or cleaning agent product form contains, based on the total weight thereof, 20 to 40 wt. %, preferably 25 to 35 wt. %, anionic surfactant.
15. The washing or cleaning agent product form according to any of the preceding points, wherein the washing or cleaning agent product form contains at least one anionic surfactant from the group consisting of C₈₋₁₈ alkylbenzene sulfonic acids, C₈₋₁₈ olefin sulfonic acids, C₁₂₋₁₈ alkanesulfonic acids, C₈₋₁₈ ester sulfonic acids, C₈₋₁₈ alkyl sulfonic acids, C₈₋₁₈ alkenyl sulfonic acids, fatty alcohol ether sulfonic acids, in particular at least one anionic surfactant from the group of C₈₋₁₈ alkyl benzene sulfonic acids.
16. The washing or cleaning agent product form according to any of the preceding points, wherein the washing or cleaning agent product form contains, based on the total weight thereof, 4 to 12 wt. %, preferably 6 to 10 wt. %, fatty acid.
17. The washing or cleaning agent product form according to any of the preceding points, wherein the washing or cleaning agent product form contains fatty acid selected from the group of caprylic acid, capric acid, lauric acid, myristic acid, palmitic acid, stearic acid, oleic acid, linoleic acid and mixtures thereof.
18. The washing or cleaning agent product form according to any of the preceding points, wherein the washing or cleaning agent product form contains, based on the total weight thereof, 15 to 30 wt. %, preferably 20 to 30 wt. %, non-ionic surfactant.
19. The washing or cleaning agent product form according to any of the preceding points, wherein the washing or cleaning agent product form contains non-ionic surfactant from the group of alkyl ethoxylates, wherein the alkyl ethoxylate is preferably selected from the group of ethoxylated primary C₈₋₁₈ alcohols, preferably C₁₂₋₁₄ alcohols having 4 EO or 7 EO, C₉₋₁₁ alcohols having 7 EO, C₁₃₋₁₅ alcohols having 5 EO, 7 EO or 8 EO, C₁₃₋₁₅ oxo alcohols having 7 EO, C₁₂₋₁₈ alcohols having 5 EO or 7 EO, in particular C₁₂₋₁₈ fatty alcohols having 7 EO or C₁₃₋₁₅ oxo alcohols having 7 EO.
20. The washing or cleaning agent product form according to any of the preceding points, wherein the washing or cleaning agent product form contains anionic surfactant and non-ionic surfactant in a weight ratio of from 3:1 to 1:2, preferably from 2:1 to 2:3 and in particular from 3:2 to 1:1.
21. The washing or cleaning agent product form according to any of the preceding points, wherein the washing or cleaning agent product form contains, based on the total weight thereof, 0.2 to 8 wt. %, preferably 0.5 to 6 wt. %, enzyme preparation.
22. The washing or cleaning agent product form according to any of the preceding points, wherein the washing or cleaning agent product form contains, based on the total weight thereof, 2 to 15 wt. %, preferably 4 to 12 wt. %, active washing or active cleaning polymer.
23. The washing or cleaning agent product form according to any of the preceding points, wherein the washing or cleaning agent product form contains an active washing or active cleaning polymer from the group of
   i)polyalkoxylated amines having a weight-average molecular weight M_{w} in the range from 600 g/mol to 10000 g/mol, which are obtainable by reacting ammonia or primary alkylamines or hydroxyalkylamines having a molecular weight of less than 200 g/mol with alkylene oxides; and/or
   ii) polyalkoxylated polyalkylene imine, which are obtainable by reacting polyalkylene imines with alkylene oxides.
24. The washing or cleaning agent product form according to any of the preceding points, wherein the washing or cleaning agent product form contains, based on the total weight thereof, 15 to 35 wt. %, preferably 20 to 30 wt. %, aqueous-organic solvent.
25. The washing or cleaning agent product form according to any of the preceding points, wherein the washing or cleaning agent product form contains, based on the total weight thereof, 5 to 18 wt. %, preferably 7 to 15 wt. %, water.
26. The washing or cleaning agent product form according to any of the preceding points, wherein the washing or cleaning agent product form contains, based on the total weight thereof, 5 to 30 wt. %, preferably 10 to 25 wt. %, organic solvent.
27. The washing or cleaning agent product form according to point 26, wherein the organic solvent is selected from the group of ethanol, n-propanol, i-propanol, butanols, glycol, propanediol, butanediol, methylpropanediol, glycerol, diglycol, propyl diglycol, butyl diglycol, hexylene glycol, ethylene glycol methyl ether, ethylene glycol ethyl ether, ethylene glycol propyl ether, ethylene glycol mono-n-butyl ether, diethylene glycol methyl ether, diethylene glycol ethyl ether, propylene glycol methyl ether, propylene glycol ethyl ether, propylene glycol propyl ether, dipropylene glycol monomethyl ether, dipropylene glycol monoethyl ether, methoxytriglycol, ethoxytriglycol, butoxytriglycol, 1-butoxyethoxy-2-propanol, 3-methyl-3-methoxybutanol, propylene glycol tert-butyl ether, di-n-octyl ether and mixtures thereof, preferably from the group of propanediol, glycerol, monoethanolamine and mixtures thereof.
28. The washing or cleaning agent product form according to any of the preceding points, wherein the washing or cleaning agent product form contains, based on the total weight thereof, 0.1 to 3 wt. %, preferably 0.2 to 2 wt. %, phosphonate.
29. The washing or cleaning agent product form according to any of the preceding points, wherein the washing or cleaning agent product form contains phosphonate and the phosphonate is selected from the group of hydroxyalkane phosphonates and/or aminoalkane phosphonates, preferably from the group of aminoalkane phosphonates and in particular from the group of ethylenediamine tetramethylene phosphonate (EDTMP) and diethylenetriamine pentamethylene phosphonate (DTPMP).
30. The washing or cleaning agent product form according to any of the preceding points, wherein the washing or cleaning agent product form contains, based on the total weight thereof, 0.2 to 4 wt. %, preferably 0.5 to 3 wt. %, fragrance preparation.
31. The washing or cleaning agent product form according to any of the preceding points, wherein the washing or cleaning agent product form is dimensionally stable.
32. The washing or cleaning agent product form according to any of the preceding points, wherein the washing or cleaning agent product form is present as a gel body.
33. The washing or cleaning agent product form according to any of the preceding points, wherein the washing or cleaning agent product form is present as a portion unit having a weight of from 5 to 30 g, preferably from 8 to 22 g.
34. A method for washing textiles, in the course of which a washing or cleaning agent product form according to any of the preceding points is introduced into a washing liquor.
35. A method for cleaning hard surfaces, in the course of which a washing or cleaning agent product form according to any of the preceding points is introduced into a cleaning liquor.
36. A method for producing a washing or cleaning agent product form according to any of points 1 to 33, comprising the steps of:
   i) providing a solution of at least one low-molecular-weight gelling agent having a molar mass of up to 2000 g/mol in at least one compound of the general formula (I)

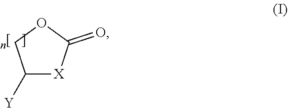

where
X represents a methylene group or an oxygen atom
Y represents a hydrogen atom or a methyl group
n represents a number from 1 to 3;
ii) providing at least one active washing or active cleaning substance;
iii) mixing the solution i) and the active substance ii) to form an active substance-containing mixture;
optionally solidifying the active substance-containing mixture.

What is claimed is:

1. A gel-like washing or cleaning agent product form, containing
a) at least one low-molecular-weight gelling agent having a molar mass of up to 2000 g/mol
b) at least one compound of general formula (I) 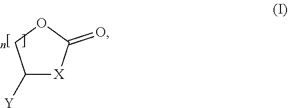
where
X represents a methylene group or an oxygen atom
Y represents a hydrogen atom or a methyl group
n represents a number from 1 to 3;
c) at least one active washing or active cleaning agent.

2. The washing or cleaning agent product form according to claim 1, wherein the washing or cleaning agent product form, based on the total weight thereof, has a proportion by weight of low-molecular-weight gelling agent a) of from 0.01 to 15 wt. %.

3. The washing or cleaning agent product form according to claim 1, wherein the washing or cleaning agent product form, based on the total weight thereof, has a proportion by weight of low-molecular-weight gelling agent a) of from 0.1 to 10 wt. %.

4. The washing or cleaning agent product form according to claim 1, wherein the washing or cleaning agent product form, based on the total weight thereof, has a proportion by weight of low-molecular-weight gelling agent a) of from 1 to 4 wt. %.

5. The washing or cleaning agent product form according to claim 1, wherein the low-molecular-weight gelling agent a) is selected from the group consisting of: cyclic dipeptides, cyclic dipeptide derivatives and dibenzylidene sorbitols and mixtures thereof.

6. The washing or cleaning agent product form according to claim 1, wherein the low-molecular-weight gelling agent is dibenzylidene sorbitol.

7. The washing or cleaning agent product form according to claim 1, wherein, in general formula (I),
X represents a methylene group
Y represents a hydrogen atom
n is a number from 1 to 3.

8. The washing or cleaning agent product form according to claim 1, wherein, in general formula (I),
X represents a methylene group
Y represents a hydrogen atom
n is 2.

9. The washing or cleaning agent product form according to claim 1, wherein, in the general formula (I),
X represents an oxygen atom,
Y represents a hydrogen atom or a methyl group
n is 1.

10. A method for washing textiles, in the course of which a washing or cleaning agent product form according to claim 1 is introduced into a washing liquor.

11. A method for cleaning hard surfaces, in the course of which a washing or cleaning agent product form according to claim 1 is introduced into a cleaning liquor.

12. A method for producing a washing or cleaning agent product form according to claim 1, comprising the steps of:
i) providing a solution of at least one low-molecular-weight gelling agent having a molar mass of up to 2000 g/mol in at least one compound of general formula (I) 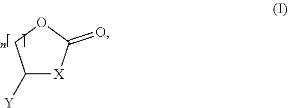
where
X represents a methylene group or an oxygen atom
Y represents a hydrogen atom or a methyl group
n represents a number from 1 to 3;
ii) providing at least one active washing or active cleaning substance;
iii) mixing the solution i) and the active substance ii) to form an active substance-containing mixture;
iv) optionally solidifying the active substance mixture.
